(19) United States
(12) Patent Application Publication
(10) Pub. No.: US 2015/0290575 A1
(43) Pub. Date: Oct. 15, 2015

(54) METHODS AND SYSTEMS FOR PURIFYING NATURAL GASES

(71) Applicants: Jeffrey Todd Rothermel, Spring, TX (US); Paul Scott Northrop, Spring, TX (US)

(72) Inventors: Jeffrey Todd Rothermel, Spring, TX (US); Paul Scott Northrop, Spring, TX (US)

(21) Appl. No.: 14/661,600

(22) Filed: Mar. 18, 2015

Related U.S. Application Data
(60) Provisional application No. 61/977,508, filed on Apr. 9, 2014.

(51) Int. Cl. B01D 53/04; G06F 17/50

(52) U.S. Cl. CPC B01D 53/0407; G06F 17/50; B01D 2257/80; B01D 2257/304; B01D 2257/504; B01D 2257/702; B01D 2257/306; B01D 2257/602; B01D 2253/116; B01D 2253/108; B01D 2253/104; B01D 2253/204

(57) ABSTRACT

A method and systems for purifying natural gases are provided herein. The method includes layering a plurality of adsorbents in a column, where the plurality of adsorbents is layered in an order. The method includes injecting a feed gas stream into the column, where the feed gas stream includes multiple components. The method includes removing the multiple components from the feed gas stream and producing a purified gas.

### CROSS REFERENCE TO RELATED APPLICATIONS

This application claims the priority benefit of U.S. patent application No. 61/977,508 filed Apr. 9, 2014 entitled METHODS AND SYSTEMS FOR PURIFYING NATURAL GASES, the entirety of which is incorporated by reference herein.

### FIELD

The present techniques relate generally to the removal of multiple gas contaminants using a reduced equipment count. More specifically, the present techniques provide for the removal of multiple gas contaminants using multiple adsorbent materials in a single adsorption bed column.

### BACKGROUND

This section is intended to introduce various aspects of the art, which may be associated with exemplary embodiments of the present techniques. This description is believed to assist in providing a framework to facilitate a better understanding of particular aspects of the present techniques. Accordingly, it should be understood that this section should be read in this light, and not necessarily as admissions of prior art.

The adsorption and removal of contaminants and impurities from gas streams is becoming a significant issue as North America expands the use of its available gas resources, including its natural gas supply. Due to the advances in gas extraction, there is now a sufficient reserve of natural gas to handle much of North America's domestic energy needs for the next century. In fact, the global gas supply is projected to increase about sixty-five percent by 2040, with twenty percent of production occurring in North America.

In the United States alone, new natural gas fields from the Appalachian Basin, Green River Basin of Wyoming, and the Uinta/Piceance Basin of Utah are rapidly developing due to the successful implementation of hydraulically fracturing shale formations. As the natural gas production fields are commercially developed, it is essential that the gas produced be properly stored for transportation to ensure commercial viability. One method of supplying clean-burning natural gas to consumers around the world includes liquefying the raw natural gas before storage and transportation of the hydrocarbon. By transforming a raw natural gas into a liquefied natural gas (LNG), a much larger volume of hydrocarbon can be stored and delivered from distant production areas to various markets. Furthermore, the process of liquefying a natural gas has proven to be particularly useful since LNG takes up about one six hundredth the volume of gaseous natural gas.

However, before liquefaction can occur, the raw natural gas may be treated to remove potentially harmful contaminants that may pose undesirable consequences to the production equipment and to the transportation infrastructure. Such contaminants can include water (H₂O), and acid gases, including carbon dioxide (CO₂) and hydrogen sulfide (H₂S). For example, the H₂O and CO₂ may freeze at liquefaction temperatures and plug the liquefaction equipment, and the H₂S may adversely impact the product specifications of LNG thereby decreasing its commercial value. Natural gas liquids (NGLs) may also be recovered to be sold separately.

Additionally, mercaptans (RSH), heavy hydrocarbons (HHC), and mercury, among other contaminants, may often be present in the raw natural gas in small concentrations. These contaminants may cause possible equipment damage or failure issues, including corrosion or metal embrittlement, or freezing and plugging of cryogenic heat exchangers. Accordingly, the separation and removal of these contaminants may also be required as a method of pre-treatment of the natural gas before liquefaction.

The conventional gas processing facility for the pre-treatment and production of LNG may include numerous key pieces of production equipment for adsorptive or absorptive processes to separate and remove the contaminants. A typical facility may include several gas separation units employing a plurality of adsorption beds, amine treatment units, and dehydration units for the removal of the contaminants.

In particular, a conventional removal process may include three or more steps including a pretreatment step, a dehydration step, and a natural gas liquids processing step. The pretreatment step may include the removal of acid gases, such as CO₂ and H₂S, as well as, organic sulfur, mercury and other impurities, through the use of a plurality of adsorption vessels. The water vapor, as a natural component of the raw natural gas, may be removed using dehydration units. Heavy hydrocarbons may be removed and collected for later commercial use. In many cases, such hydrocarbons may be processed using traditional gas processing technologies. However, such methods may leave small quantities of components like benzene in the processed gas stream. These heavy hydrocarbons could freeze and accumulate in the cryogenic heat exchanger, causing plugging of the exchanger. This may require shutdown and de-riming to remove the blockage.

United States Patent Application Publication No. 2011/0185896 by Sethna et al. describes a method for removing contaminants from a natural gas stream such as a biogas/landfill gas stream. The natural gas stream is initially fed to a first adsorption unit for removal of certain contaminants and then to a second adsorption unit for the removal of additional contaminants. Alternatively, a membrane stage may be employed as another step between the adsorption units.

U.S. Pat. No. 7,442,233 to Mitariten describes a process for the removal of heavy hydrocarbons, carbon dioxide, hydrogen sulfide, and water from a raw natural gas feed stream. The process includes a three-step process involving the adsorption of heavy hydrocarbons and water on an adsorbent bed selective for the same, a subsequent aqueous lean amine treatment for the absorptive removal of acid gases, such as carbon dioxide and hydrogen sulfide, and an adsorptive removal process for water vapor.

Related information may be found in U.S. Pat. Nos. 8,388,732 and 8,282,707. Further information may also be found in United States Patent Application Publication Nos. 2012/0180389. Additional information may be found in European Patent Application Publication No. 2501460 A1.

The effective removal of contaminants before liquefaction often includes the use of a plurality of production and processing units in multiple stages. Accordingly, there is a need to reduce the infrastructure requirements for the pre-treatment of a gas by providing multiple adsorbents in a vessel for the effective removal of various contaminants.

### SUMMARY

An exemplary embodiment provides a gas purification column including a feed gas inlet for introducing a gas flow. The gas purification column includes a plurality of adsorbents to adsorb multiple components within the gas flow. The plurality of adsorbents are layered within the column, where each adsorbent has a calculated bed length.

Another exemplary embodiment provides a column for the purification of a natural gas including a feed gas inlet for introducing a natural gas flow. The column includes a plurality of adsorbents to adsorb multiple components within the natural gas flow, where the plurality of adsorbents is layered within the column and each adsorbent has a calculated bed length.

Another exemplary embodiment provides a method of purifying a gas, including layering a plurality of adsorbents in a column, where the plurality of adsorbents is layered in an order injecting a feed gas stream into the column. The feed gas stream includes multiple components and removing the multiple components from the feed gas stream. The method includes producing a purified gas.

### DESCRIPTION OF THE DRAWINGS

The advantages of the present techniques are better understood by referring to the following detailed description and the attached drawings, in which:

FIG. 1 is an illustration of a subsea natural gas field harvested for the production of gas;

FIG. 2 is a block diagram of a system for the removal of a plurality contaminants in a gas using an adsorption column;

FIG. 3 is an illustration of an adsorption column for the removal of a plurality of containments from a gas stream;

FIG. 4 is a method of designing a column for the removal of contaminants from a gas;

FIG. 5 is a method of designing a column for the removal of contaminants from natural gas;

FIG. 6 is an illustration of a packed adsorption bed in a column for the purification of shale oil;

FIG. 7 is an illustration of a packed adsorption bed in a column for the purification of liquid natural gas (LNG); and

FIG. 8 is an illustration of a packed adsorption bed in a column for the purification of production fluid from a reservoir well.

### DETAILED DESCRIPTION

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

The term “absorption” is a process by which a gas, liquid, or dissolved material is assimilated into a liquid material and defined in terms of absorptive volume per unit mass.

The term “absorption column” refers to a mass transfer device that enables a suitable liquid solvent, i.e. absorbent, to selectively absorb a contaminant, i.e. absorbate, from a fluid containing one or more other contaminants.

The term “adsorption” is a process by which a gas, liquid, or dissolved material is assimilated onto the surface of a solid material and defined in terms of adsorptive surface area per unit mass.

The term “adsorption vessel” or “adsorption column” refers to a mass transfer device that enables a suitable adsorbent to selectively adsorb a contaminant, i.e. adsorbate, from a fluid containing one or more other contaminants. The term “adsorption vessel” or “adsorption column” may further refer to a unit system incorporating at least one vessel containing a solid adsorbent such as silicon dioxide or molecular sieves, which preferentially adsorbs at least one constituent from a feed gas. The adsorption vessel or column also may comprise valving to direct both feed and regeneration gases through the bed(s) at varying time intervals.

The term “adsorbent bed” refers to a volume of adsorbent materials that have a structural relationship to each other, wherein the structural relationship is maintained even when the materials are not contained in a vessel. In some contexts, the term may exclude a bed comprising adsorbent particles simply dumped into a vessel. Exemplary structural relationships include, for example, a monolithic “brick,” layered surfaces, channeled monoliths, and the like. Structured adsorbents contain at least a selective adsorbent material and a plurality of substantially parallel flow channels. The selective adsorbent material is comprised of high surface area solids and excludes polymeric material. However, the structured adsorbent bed may also include a “binder” to hold adsorbent particles together. This binder may be a polymeric or inorganic material such as clay. The structured adsorbent bed may also contain a material that acts as a thermal mass serving to limit the temperature rise of the structured adsorbent bed when molecules are selectively adsorbed.

The term “adsorbent” is any material or combination of materials capable of adsorbing gaseous components. The term “adsorbent” refers to a specific type of adsorbent material, for example, activated carbon. An adsorbent may be in the form of porous granular material such as, for example, beads, granules, or extrudates. Alternatively, an adsorbent may be in the form of a self-supported structure such as, for example, a sintered bed, monolith, laminate, or fabric configuration. The present techniques can be applied to any of these types of adsorbents. A bed of adsorbent material is defined as a fixed zone of one or more adsorbents through which the gas mixture flows during the separation process. The bed of adsorbent material may contain a single type of adsorbent or alternatively may contain layers or zones of different types of adsorbents.

The term “bed” refers to a mass of adsorbent material installed in a single vessel into which gas is introduced and from which gas is withdrawn during the multiple steps of a cyclic pressure swing adsorption (PSA), or temperature swing adsorption (TSA) process according to methods known in the art. The term “composite bed” is defined herein as a total mass of adsorbent material that consists of two or more amounts of adsorbent material contained respectively in two or more parallel vessels. The total amount of adsorbent material in the composite bed is the sum of the amounts of adsorbent material contained in the two or more parallel vessels. The adsorptive material in the two or more parallel vessels is subjected collectively to the total gas inflow and outflow of the composite bed during the steps of the PSA (or TSA) cycle such that the adsorbent material in each vessel is subjected to the same process cycle step of the same duration in a given time period. The parallel vessels therefore operate synchronously throughout the steps in the PSA (or TSA) cycle.

For the term “Bed length,” see “Mass Transfer Zone” [Note: Mass Transfer Zone is one component used in the calculation of the bed length].

The term “Cₙ hydrocarbon” represents a hydrocarbon molecule with “n” carbon atoms such as C₅ or C₆.

The term “contaminant” refers to a material, such as a compound, an element, a molecule, or a combination of molecules up to and including particulate matter, that are present in an input gas and are not desired in the final conditioned gas. The contaminants can be solid, liquid or gaseous. For example, when the input gas is a syngas produced from the conversion of carbonaceous feedstock into a gas product in a gasification system or converter, the input gas may contain contaminants such as sulphur, halide species, slag and char particulates, nitrogen species (such as ammonia and hydrogen cyanide), and heavy metals (such as mercury, arsenic, and selenium).

The term “feed stream” also includes a composition prior to any treatment, such treatment including cleaning, dehydration and/or scrubbing, as well as any composition having been partly, substantially or wholly filtered for the reduction and/or removal of one or more compounds or substances, including but not limited to sulphur, sulphur compounds, carbon dioxide, water, and C₂+ hydrocarbons.

The term “liquefied gas” as used herein refers to any gas that can be stored or transferred in a liquid phase. For example, the term “liquefied gas” includes, but is not limited to, liquefied natural gas (LNG), liquefied petroleum gas (LPG), liquefied ethylene, natural gas liquid, liquefied methane, liquefied propane, liquefied butane, liquefied ammonia, combinations thereof and derivatives thereof. For simplicity and ease of description, the embodiments will be further described with reference to liquefied natural gas (LNG).

The term “LNG” refers to natural gas that is reduced to a liquefied state at or near atmospheric pressure.

The term “heavy hydrocarbons” refers to a natural gas liquid that may have a higher molecular weight, as compared to ethane, propane, butanes, and pentanes. Examples of a heavy hydrocarbon may include C₅+, (which may be referred to as natural gasoline), or C₆+.

The term “mass transfer zone” or “MTZ” refers to the portion of the bed through which the concentration of the adsorbate is reduced from essentially inlet to outlet conditions. The active adsorption process in a packed bed generally does not occur over the whole bed length (e.g., the saturated bed length, the MTZ, and the unused bed) during the entire operation time. In other words, a certain length of bed, the MTZ, is involved in the adsorption process and proceeds through the bed, from the inlet point to the outlet point during the operation time. Within the MTZ, the degree of saturation of the adsorbate varies from 100% to zero, and the contaminant concentration varies from the inlet concentration to zero.

The term “natural gas” often refers to raw natural gas, but sometimes refers to treated or processed natural gas. Raw natural gas is primarily comprised of methane (>50%), but may also include numerous other light hydrocarbons (0-30%) including ethane, propane, and butanes. Heavy hydrocarbons, including pentanes, hexanes and impurities like benzene may also be present in small amounts (<10%). Furthermore, raw natural gas may contain small amounts of non-hydrocarbon impurities, such as nitrogen (0-10%), hydrogen sulfide (0-5%), carbon dioxide (0-30%), and traces of helium, carbonyl sulfide, various mercaptans, and water. Filtered natural gas is primarily comprised of methane, but may also contain small percentages of other hydrocarbons, such as ethane, propane, butanes and pentanes, as well as small percentages of nitrogen and carbon dioxide.

The term “pretreatment of natural gas” refers to separate steps located either upstream of the cooling cycles or located downstream of one of the early stages of cooling. The following is a non-inclusive listing of some of the available means, which are readily known to one skilled in the art. Acid gases and to a lesser extent mercaptans are routinely removed via a chemical reaction process employing an aqueous amine-bearing solution. This treatment step is generally performed upstream of the cooling stages. A major portion of the water is routinely removed as a liquid via two-phase gas-liquid separation following gas compression and cooling upstream of the initial cooling cycle and also downstream of the first cooling stage in the initial cooling cycle. Mercury is routinely removed via mercury sorbent beds. Residual amounts of water and acid gases are routinely removed via the use of properly selected sorbent beds such as regenerable molecular sieves.

The term “vessel” refers to a hollow structure enclosing an interior volume containing adsorbent material and having at least one gas inlet and at least one gas outlet. Multiple vessels are arranged in parallel flow configuration in which an inlet gas stream is divided into portions by an inlet manifold that directs the portions into respective vessels during steps in a PSA (or TSA) cycle. The outlet gas streams from each parallel vessel are combined into a single outlet gas stream by an outlet manifold. A manifold is generically defined as a piping assembly in which a single pipe is connected in flow communication with two or more pipes. The inlet gas stream passes into the composite bed collectively formed by the adsorbent material in the parallel vessels and the outlet stream is withdrawn from the composite bed collectively formed by the adsorbent material in the parallel vessels.

### Overview

Liquefaction of natural gas is a commercially important method of supplying clean-burning fuel to consumers around the world. Before the natural gas can be liquefied, many types of contaminants may be removed to low levels, including H₂S, mercaptans, CO₂, HHC, H₂O, and mercury. In some cases, several stages of chemical or physical adsorbents and solvents can be used to reduce the concentration of such contaminants to acceptable levels.

Since the solvent treatment may saturate the gas with water, the gas is often cooled to reduce the concentration of H₂O vapor. The partially-dehydrated gas may then pass through a particular type of adsorbent, which may be tailored to meet the tight water specifications for natural gas. Other impurities may also be removed using varied adsorbents. For example, acid gases, HHC, and RSH contaminants may be removed each by a different type of adsorbent based on such factors including the adsorption strength of the contaminant to be adsorbed, the amount of gas to be processed, the targeted removal capacity of the contaminants, and the quality specifications of the end-product gas, among other considerations. Additionally, mercury, which may be deleterious to process equipment, may also be present in the gas and may be removed using a particular type of adsorbent specifically designed for mercury purification.

Accordingly, the present techniques provide for the purification of a gas stream by the removal of undesirable contaminants in a reduced equipment-count facility with reduced processing steps. More specifically, various embodiments may include a gas purification column packed with a plurality of varied adsorbents, where each layer of adsorbent may be layered in the column. The length of each layer of adsorbent may be based on a calculated bed length. Furthermore, in various embodiments, a method of purifying a gas may include passing the gas through layers of a plurality of adsorbents arranged in a particular order based on the adsorption strength of each contaminant to be adsorbed. Additionally, some embodiments may provide a method of designing a gas purification column for the removal of multiple contaminants by providing a calculated bed length for each adsorbent based on the maximum weight percentage of contaminant to be adsorbed. The design of the gas purification column may also include layering each adsorbent based on the adsorption strength of each contaminant to be adsorbed.

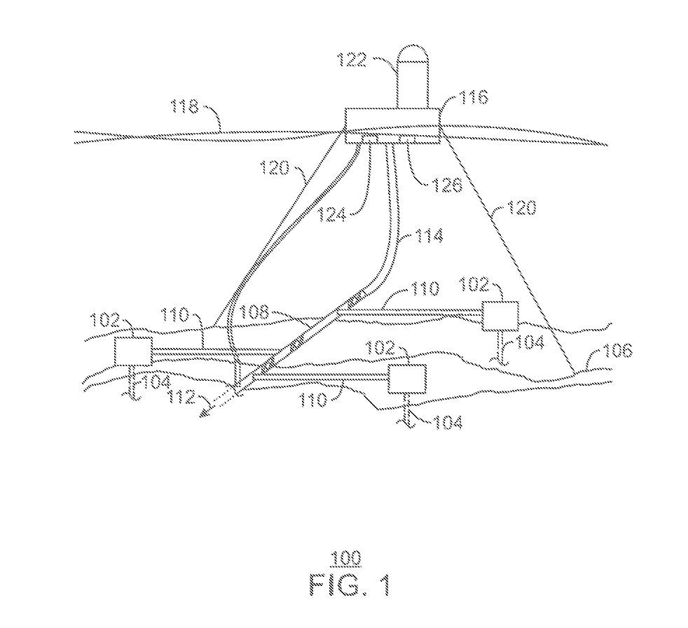

FIG. 1 is an illustration of a subsea field 100 that can produce gas, either off-shore or on-shore. The field 100 can have a number of wellheads 102 coupled to wells 104 that harvest hydrocarbons from a formation (not shown). As shown in this example, the wellheads 102 may be located on the ocean floor 106. Each of the wells 104 may include single wellbores or multiple, branched wellbores. Each of the wellheads 102 can be coupled to a central pipeline 108 by gathering lines 110. The central pipeline 108 may continue through the field 100, coupling to further wellheads 102, as indicated by reference number 112. A flexible line 114 may couple the central pipeline 108 to a collection platform 116 at the ocean surface 118. The collection platform 116 may be, for example, a floating processing station, such as a floating storage and offloading unit (or FSO), that is anchored to the ocean floor 106 by a number of tethers 120 or it may be an on-shore facility.

For hydrocarbon processing, the collection platform 116 may have equipment for processing, monitoring, and storing the harvested hydrocarbons and the like, including a gas purification column, e.g., an adsorption column, 122. The collection vessel 116 may export the processed hydrocarbons to shore facilities by pipeline (not shown).

Prior to processing of the hydrocarbons on the collection platform 116, the concentration of components in the production fluids brought up the flexible line 114 from the central pipeline 108 may be monitored, for example, by an analyzer 124 located at the collection vessel 116 or at any number of other points in the natural gas field 100. The analyzer 124 may determine the concentration of the varied phases in the hydrocarbon, the concentration of hydrocarbons within the production fluid, the concentration of other processed fluids, including trace gas contaminants, within the production fluid, in addition to a number of other parameters. In varied embodiments, the identified gas contaminants may include H₂O, H₂S, CO₂, mercury, HHC, RSH, hydrogen, nitrogen, and other impurities. Further, in some embodiments, the gas analyzer 124 may include a flame photometric detector gas chromatograph (FPD GC), a mass spectrometer, an x-ray fluorescence (XRF) detector, or an x-ray diffraction (XRD) spectrometer, in order to identify many of the naturally-occurring impurities in the hydrocarbons collected from the field 100.

Additionally, a flow measurement device 126 may be placed in central pipeline 108 to determine the mass flow rate or quantity of the moving production fluid for control optimization of the fluid at various pressures and temperatures. The process of monitoring the production fluid containing a concentration of contaminants that may enter the adsorption column 122 can prevent adverse effects from hindering the performance of a packed adsorption bed within the column 122, including incidental carryover of liquid or solid contaminants into the production gas that could reduce the longevity and viability of the adsorption bed. In some embodiments, once the adsorption bed has received the maximum weight percentage of contaminant to be adsorbed, the process of regeneration may be implemented to remove the contaminants, thereby preventing oversaturation of the adsorption bed and contamination of a purified end-product. The facilities and arrangement of the facilities is not limited to that shown in FIG. 1, as any number of configurations and other facility types may be used in embodiments.

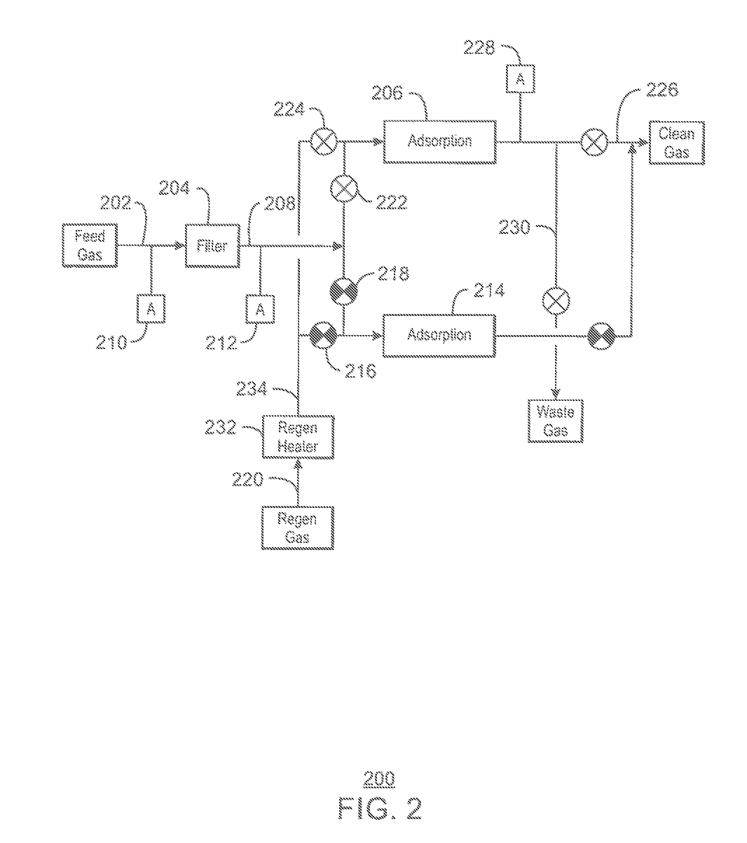

FIG. 2 illustrates a block diagram of a system 200 for the purification of a feed stream in an adsorption column by removing a plurality contaminants within the stream. To protect the gas processing equipment, a harvested gas may be filtered before it is further processed. As shown in FIG. 2, a feed stream 202 may flow into a filter-coalescer 204 in order to pre-treat the gas before it can be fed into an adsorption column 206. The filtering process may include removing any entrained liquid or solid particles that may be present in the feed stream 202. The filtered feed stream 208 may flow into the adsorption column 206 for further processing. In some embodiments, the feed stream 202 and the filtered feed stream 208 may be monitored using analyzers 210 and 212 before and after filtration in order to determine the initial concentration of contaminants that may flow into the adsorption column 206.

The adsorption column 206 may be specially designed to handle various contaminants in the filtered feed stream 208 in a single-step approach. The adsorption column 206 utilizes a solid-mass separating agent, or a packed adsorption bed, packed inside the column 206 to effectively separate and remove the contaminants from the filtered feed stream 208, as it flows through the bed. As shown in FIG. 2, the purification system 200 may include two adsorption columns where the adsorption column 206 may be considered as an online adsorption column and the other adsorption column may be considered as a stand-by column 214 that can be isolated by the use of valves within the system 200.

The stand-by column 214, which may be in a stand-by mode, may act as a back-up vessel when the adsorption column 206 may be physically unavailable or in regeneration mode. The stand-by mode may refer to a mode of operation where the stand-by column 214 may include a regenerated bed where the filtered feed stream 208 does not pass. Specifically, the valves 216 and 218, as shown in FIG. 2 in a closed position, may indicate that neither the filtered feed stream 208 nor a regeneration gas stream 220 flows into the stand-by column 214. Instead, the filtered feed stream 208 may flow into the adsorption column 206 through an open valve 222. Further, the regeneration gas stream 220 may flow into the adsorption column 206 through an open valve 224 when the desired saturation has occurred. Additionally, other valves can be placed throughout the system 200 to assist in directional flow. In operation, it should be understood that a single adsorption column, e.g., adsorption column 206, can meet the quality specifications for the effective removal of contaminants in a one-step purification approach.

The packed adsorption bed can include a plurality of layered adsorbents. The contaminants within the filtered feed stream 208 may be adsorbed by and removed via the plurality of adsorbents. In the purification system 200, the process of adsorption may be described as the adhesion of a particular contaminant within a production fluid brought into contact with a surface of an adsorbent due to a force field within that surface. Thus, the production fluid may be decontaminated since molecules of the contaminant have been transported from within the production fluid to a surface of the adsorbent, and into the pores thereof. Since the surface of the plurality of adsorbents can exhibit different affinities for various containments, the adsorption process may offer a straightforward means of purifying or removing undesirable contaminants from the filtered feed stream 208 as it flows through the packed adsorption bed.

After contaminant removal, a clean gas stream 226 may exit the adsorption column 206 to be further processed in a liquefaction process, sold into a pipeline, or stored for commercial usage. In some embodiments, an analyzer 228 may be placed after the adsorption column 206 to determine if the required specifications for contaminant removal have been achieved during purification. Additionally, a waste gas stream 230, which may be removed during regeneration of the column by the regeneration gas stream 220, may be split from the clean gas stream 226 and directed to waste removal.

During the continual injection of the filtered feed stream 208 into the adsorption column 206, the adsorption bed of the column 206 may become oversaturated with adsorbed contaminants. Once the adsorption bed nears or reaches maximum saturation, regeneration of the packed bed can be carried out by flowing the regeneration gas stream 220 into the adsorption column 206. The flowing regeneration gas 220 may act as a purge gas to effectively desorb and remove the contaminants from the packed adsorption bed and purge the bed for future production cycles. The desorbed contaminants can enter into the waste gas stream 230 or be separated for further processing.

The stream of regeneration gas 220 may be heated in a high-temperature regeneration heater 232 to generate a heated regeneration gas stream 234. In operation, the heated regeneration gas stream 234 may be directed into the adsorption column 206 to remove the previously adsorbed contaminants that may have been brought into contact with the plurality of adsorbents. In some embodiments, the regeneration gas 220 can be a thermally stable regeneration gas, including air, nitrogen, or flue gas, or it may be a slipstream stream of the generated clean gas so as not to jeopardize production purity. The facilities and arrangement of the facilities is not limited to that shown in FIG. 2, as any number of configurations and other facility types may be used in embodiments.

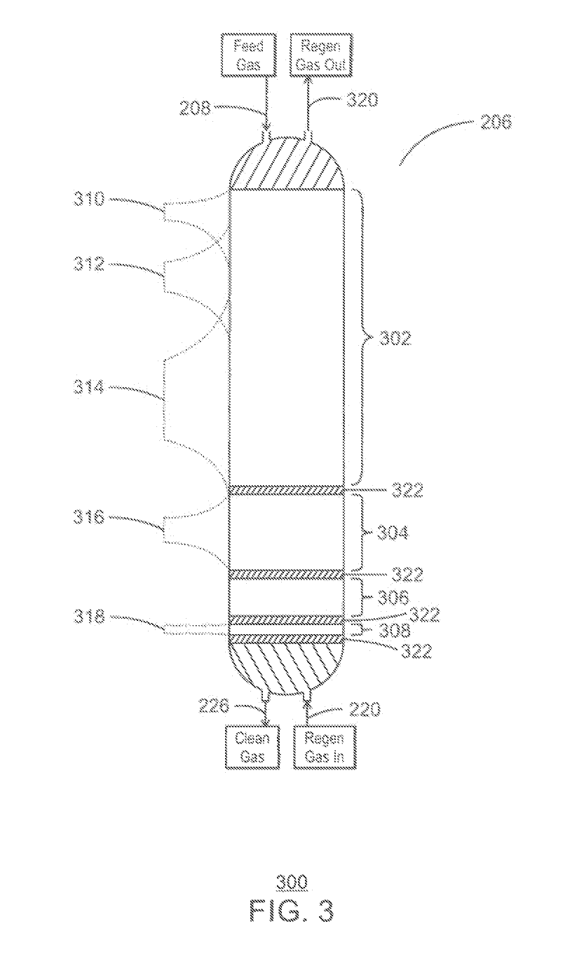

FIG. 3 illustrates a packed bed adsorption column 300 for the purification of a feed stream. Like numbered items are as discussed with respect to FIG. 2. Even after filtration, a filtered feed stream may continue to contain undesirable contaminants that can impact the integrity of the production facility. In operation, an adsorption process to remove such undesirable contaminants includes passing a contaminated gas stream through layers of adsorbents. As the contaminated gas stream passes through the layers of adsorbents, the molecules of the contaminants may adsorb or stick to the surface of the adsorbents, or pass to the pores therein. The adsorbed contaminants on the surface of or in the pores of an adsorbent may not be destroyed but may continue to adhere to the surface of the adsorbent until removed by desorption.

Through the process of adsorption, the filtered feed stream 208 can be purified of its contaminants to produce a clean gas stream 226. As shown in FIG. 3, the adsorption column 206 includes a feed gas inlet where the filtered feed stream 208 enters the column 206.

The adsorption column 206 may include an adsorption bed, including a plurality of layered adsorbents 302, 304, 306, 308. The initial selection of the type of adsorbent utilized may be based on feed parameters such as the composition, pressure, and the temperature of the feed gas, the types and nature of the contaminants in the feed gas, as well as the desired end-product specifications. For example, the gas cleaning process may involve the removal of H₂O vapor, CO₂, H₂S, and other contaminants, which may tend to concentrate to higher levels during gas processing.

Thus, in the pre-treatment of natural gas for potential liquefaction, H₂O vapor may be a present as a contaminant in a substantial concentration. The removal of the H₂O vapor during pre-treatment may prevent the accumulation of liquid water in the in the pipelines of the production facility. Further, any water accumulation may lead to the formation of natural gas hydrates, i.e. a solid material that may block production lines. Accordingly, an adsorbent selected for the removal of H₂O vapor may be layered in the adsorption bed.

Furthermore, H₂S and CO₂, in combination with liquid H₂O, may enhance corrosion and metal embrittlement in the process equipment. The H₂S is toxic in nature and highly flammable. Conversely, CO₂ may be non-flammable but can displace oxygen leading to suffocation. Accordingly, adsorbents to remove both H₂S and CO₂ may be layered in the adsorption bed.

The use of mercaptans (RSH) can be an effective warning agent and, thus, may be added to detect the presence of natural gas. However, the odor of the mercaptans can be strong and repulsive. Thus, an adsorbent layer to remove the RSH, as an undesirable contaminant due to its odor, may be layered in the adsorption bed.

Natural gas may also contain natural gas liquids (NGLs), including heavy hydrocarbons (HHC) that could condense in the pipeline and form a liquid phase. Heavy hydrocarbons, such as C₅+ and C₆+, in sufficient concentration can condense, causing erratic pressure variations that can adversely impact the reliability or safety of a production facility. Thus, an adsorbent layer to remove HHC may be layered in the adsorption bed. It should be noted that the natural gas liquids that are removed can be blended with other components and sold as a valuable product.

Elemental mercury may also be present in some natural gas streams to varying levels. In a cryogenic gas processing facility, mercury may cause corrosion, equipment failure, and catalyst deactivation. For example, the aluminum heat exchangers that may be found in a LNG plant may be susceptible to liquid-metal embrittlement (LME) due to mercury contamination. The LME can initiate a corrosive attack of the aluminum and cause crack initiation and propagation within the equipment. Thus, an adsorbent layer in the adsorption bed for the removal of mercury may improve LNG productivity and profitability while sustaining equipment.

A molecular (mole) sieve may be one type of adsorbent within an adsorption bed that can be utilized for the removal of contaminants from a gas stream. The mole sieve may be a microporous crystalline solid material containing charged active sites that may actively adsorb gases and liquids. As an adsorbent, a mole sieve may be layered within the adsorption column 206 to effectively remove undesirable contaminants from the filtered feed stream 208. In some embodiments, the mole sieve in the adsorption bed of the column 206 may include a highly crystalline material, including zeolites (crystalline metal aluminosilicates), which upon regeneration can selectively remove contaminants. Further, the plurality of adsorbents can be in the form of particulates, extruded solids, functionalized solids, monoliths structures, or any combinations thereof. Based on the molecular size of a contaminant, a particular mole sieve may be selected due to its pore size, where molecules of a contaminant with a critical diameter that is less than the pore size, may be efficiently adsorbed while larger molecules of a contaminant may be excluded. The standard mole sieve pore sizes may include 3A, 4A, 5A, and 10A (13X) types.

Since the adsorption capacity of the adsorbents 302, 304, 306, 308 may be directly related to the molecular weight and polarity of the contaminants adsorbed, higher molecular weight and more polar contaminants, including H₂O, H₂S, and CO₂, may be adsorbed more strongly than lighter molecular weight and less polar components, such as methane, ethane, or nitrogen. Thus, the adsorbent 302 may initially be saturated with the higher molecular weight contaminants.

Due to this competitive nature, the H₂O vapor in the filtered feed gas 208 may be more strongly attracted through molecular scale forces to the surface of the adsorbent 302 than that of H₂S and CO₂. Thus, the H₂O vapor may tend to collect on the inlet portion of the adsorbent column 206 and may displace the more weakly-adsorbed contaminants, H₂S and CO₂, which may continue to flow through the adsorption column 206 until the molecular forces of both H₂S and CO₂ bind with a lower portion of the adsorbent 302. Accordingly, other layers of adsorbent 304, 306, 308 in the column 206 may adequately capture the less competitive contaminants that cannot be adsorbed by the adsorbent 302.

As shown in FIG. 3, the concentration of the adsorbed H₂O vapor on the adsorbent 302, as a function of position and at a particular time, may be derived from physical adsorption isotherms. Typically, isotherms can be used to estimate the performance of the various layered adsorbents as they may relate to effective contaminant removal or varying inlet gas concentrations. In FIG. 3, the concentration profile for H₂O vapor 310 depicts the concentration of H₂O vapor that may be adsorbed by the adsorbent at a particular time. The profile 310 illustrates that the concentration of H₂O vapor may increase significantly to a point of plateauing. Thereafter, as the adsorbent 302 in the adsorption bed reaches a level of maximum H₂O saturation, the concentration of adsorbed H₂O vapor may level-off and lessen as the bed is not yet fully saturated with adsorbed H₂O. Further, the profile for adsorbed H₂O vapor 310 may exhibit a relatively short mass transfer zone since H₂O may be preferentially adsorbed over both H₂S and CO₂ due to the stronger interaction between the H₂O vapor molecules and the adsorbent 302. As seen by the profile for H₂S 312 and the profile for CO₂ 314, the mass transfer zones are longer, due to the lesser interaction between the H₂S or CO₂ molecules and the adsorbent 302.

In some embodiments, for the H₂O vapor, H₂S, and CO₂, a 4A type mole sieve may be utilized to remove the contaminants. In other embodiments, the adsorbent layer for H₂O vapor can include alumina or silica gel beads. In some embodiments, for H₂S removal, adsorbents such as a metal-organic-framework (MOF) mole sieve or an amine-treated mole sieve can be utilized to meet the H₂S specifications. In various embodiments, a MOF mole sieve, deca-dodecasil 3R (DDR) zeolite mole sieve, or alumina adsorbent can be used to adsorb the CO₂ at higher concentration, whereas, at lower concentrations, a 4Å mole sieve can be implemented.

While the molecules of H₂S and CO₂ may exhibit a lower bonding affinity to the adsorbent 302 than H₂O vapor, such contaminants may be more powerfully bonded to an adsorbent than that of RSH, HHC, or mercury. Accordingly, the adsorption impact of the RSH and HHC may be relatively minor compared to H₂O, H₂S, or CO₂, due to the lower molecular weights of such contaminants. This may be exhibited by the profile for RSH 316. As the filtered feed stream 208 moves through the adsorption column 206, the RSH profile 316 may exhibit a sharper peak and a more constant plateau in its respective adsorbent layer 304.

Furthermore, the molecules of the RSH, to some extent, may be too large to fit into the pores of a 3A, 4A, or 5A mole sieve adsorbent. Thus, a large pore mole sieve, such as a 13X mole sieve, may be implemented as the adsorbent layer 304 to meet the maximum allowable specification for the RSH in the effluent gas.

In FIG. 3, a layer of adsorbent 306, including a layer of silica gel, to remove HHC may be packed in the adsorption bed. In some embodiments, the HHC may be removed to low concentration levels so as to avoid any possibility of freezing in a cryogenic exchanger in the production facility.

Although mercury may be present in natural gas in low concentrations, its harmful effects on human health and industrial equipment can be serious. Accordingly, natural gas streams can be decontaminated of mercury using a non-regenerable guard bed 308 that can be placed downstream of the previously mentioned layered adsorbents 302, 304, 306. The guard bed 308 may include beads of activated carbon impregnated with elemental sulfur (S). In operation, the mercury may chemically bond with sulfur to form mineral cinnabar. The mineral cinnabar, containing the mercury contaminant, may then be removed in a non-hazardous form where the guard bed 308 can be designed to decrease trace levels of mercury down to at least 1 ppb. Since the concentration of mercury initially may be low in the production fluid, the length of mass transfer zone may be relatively short. Accordingly, the concentration profile for mercury 318 may be relatively sharp and narrow, as shown in FIG. 3. In some embodiments, a silver-impregnated mole sieve adsorbent may be layered in the adsorption column to remove the mercury from the filtered feed stream 208.

After at least one of the adsorbent layers has reached a maximum level of contaminant saturation, the contaminants may need to be purged from the adsorption bed to prevent oversaturation (or breakthrough) and to regenerate the bed for the possibility of a re-injection of the filtered feed stream 208. A slip stream of regeneration gas 220 may be injected into the adsorption column 206 to purge and remove the contaminants that are adsorbed into the adsorbents. The regeneration of the adsorbent bed takes place at high temperatures, typically in the range of at least 500° F., and may result in an out-regeneration stream 320 containing the previously adsorbed contaminants, which can be further processed to generate a local fuel gas stream, recycled back into the filter stream, or removed as waste.

As shown in FIG. 3, the regeneration gas 220 may be injected in a countercurrent flow to the filtered feed stream 208. Using countercurrent flow may allow the regeneration gas to first contact the adsorption bed at an outlet of the bed, thereby, more fully regenerating the bottom of the bed. In various embodiments, a co-current regeneration stream flowing in conjunction with the filtered feed stream 208 can be implemented. The co-current regeneration stream may require bed inlet temperatures that can be at least 20 degrees higher than countercurrent regeneration to obtain the same product dewpoint.

Additionally, in other embodiments, support grids 322 may be implemented between the plurality of adsorbents as an effective support system and divider between the different adsorbent layers. The support grids 322 may include molecular sieve support grids, distribution plates, and separation plates, in any combination thereof. For separation of adsorbent layers only (not support), floating mesh screens may be used.

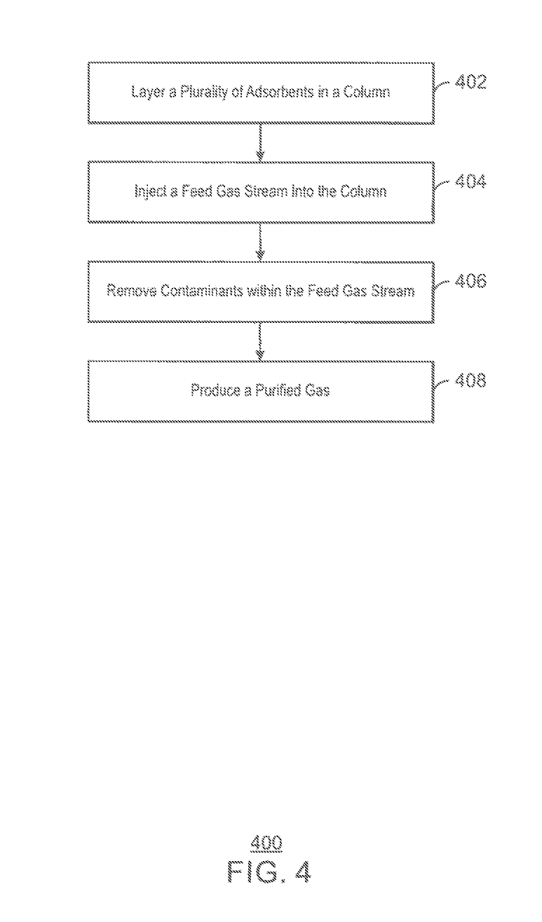

FIG. 4 is a process flow diagram of a method 400 for purifying contaminants from a gas stream. Specifically, the method 400 may provide for the removal of contaminants using a plurality of adsorbents to produce a purified gas for commercial use. According to embodiments described herein, the method 400 may be implemented by an adsorption column containing an adsorption bed. The method begins at block 402, at which, a plurality of adsorbents may be layered in the adsorption column.

At block 404, a feed stream, including various contaminants, may be injected into the adsorption column. In some embodiments, the plurality of layered adsorbents can be layered in a particular order where the order of the adsorbents may be based, at least in part on the adsorption strength of the contaminant to be adsorbed. Additionally, a calculated bed length can be provided for each of the plurality of adsorbents, based at least in part on the maximum weight percentage of component that can be adsorbed, as determined by isotherms measured for a particular contaminant on that adsorbent. At block 406, the injected feed stream may be stripped of any contaminants through the use of the plurality of adsorbents. At block 408, a purified gas may be generated for further commercial use after the removal of the contaminants from the feed stream. In some embodiments, the feed gas stream and the purified gas can be monitored to determine the percentage volume of each contaminant before and after the adsorption, and to identify when a breakthrough is imminent.

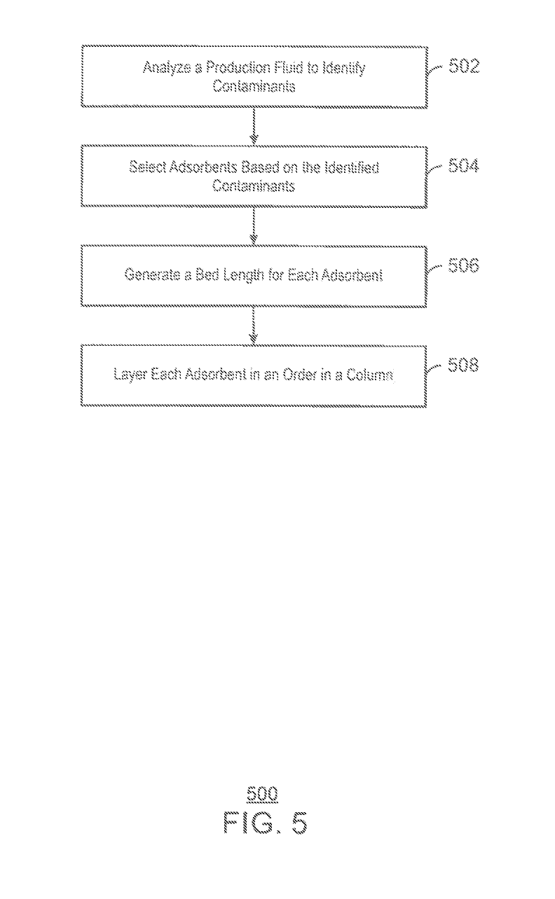

FIG. 5 is a process flow diagram of a method 500 for designing an adsorption bed for contaminant removal from a gas stream. According to embodiments described herein, the method 500 may provide for the design of a purification column containing a plurality of layered adsorbents to remove multiple contaminants from the gas stream. The method begins at block 502, at which a gas may be analyzed to identify a plurality of contaminants within a gas. At block 504, an adsorbent is selected based on each type of identified contaminant. In some embodiments, a support plate may be placed between the adsorption layers to act as a divider and to provide support for more fragile layers of adsorbents. At block 506, a bed length for each adsorbent may be generated, based at least in part, on the maximum weight percentage of contaminant to be adsorbed by a particular adsorbent. At block, 508, each adsorbent may be layered in the column in an order, based at least in part, on the adsorption strength of the contaminant to be adsorbed by a particular adsorbent.

### Examples

An important parameter in designing an adsorption column with a multi-layer adsorption bed is determining the bed length for each adsorbent layer. The bed length can be defined as a length of the adsorption bed through which the concentration of the contaminant can be reduced from inlet to outlet conditions. The total bed length for a given adsorbent can be split into different lengths, including a length of a saturated bed (Lₓ), and a length of a mass transfer zone (L_{MTZx}), and a length of unused bed. The length of the unused bed may be the length remaining prior to breakthrough of that contaminant.

The mass transfer zone (MTZ) is where active adsorption takes place and includes the length where the adsorption bed goes from fully-saturated to “untouched” for a particular contaminant. Within the MTZ, the degree of saturation with a contaminant may vary from 100% to effectively zero. In operation, the MTZ may travel through the adsorption bed, leaving behind a section of the bed that may be completely saturated with contaminant, and a leading section of the bed that has not adsorbed any contaminant. The MTZ may continue to travel through the adsorption bed until the contaminant reaches the breakthrough point. Then, the adsorbent may need to be regenerated to prevent excessive contaminants from entering the production fluid. Thus, each layer of adsorbent may have sufficient capacity to handle the anticipated quantity of its respective contaminant during service. The saturated bed length of contaminant x can be calculated by first determining the total mass of the contaminant to be adsorbed during the specified cycle time (often 12 hours, or 0.5 days). So, the mass of contaminant to be adsorbed is:

Mₓ=(Q/379.48)*Wₓyₓt (1)

In Eq. 1, Mₓ is the mass (e.g., in lbs) of contaminant x to be removed in the given cycle time t (e.g., in days or fractions thereof), where Q is the standard volumetric flow rate of feed gas (e.g., MMSCF/D), wₓ is the molecular weight of contaminant x (e.g., in lbs/lb-mole) and yₓ is the mole fraction of contaminant in the gas (dimensionless). The length of saturated adsorbent bed required (at end of life conditions, when adsorbent capacity is at its lowest), as shown below in Eq. 2.

Lₓ=Mₓ/(πR²ρ*Sₓ) (2)

In Eq. 2, Lₓ is the length (e.g., in ft) of the fully-saturated adsorption zone of component x, Mₓ is the total mass (e.g., in lbs) of contaminant x to be adsorbed (obtained from Eq. 1), R is the radius of the bed (e.g., in ft), ρ is the bulk density of the adsorbent (e.g., 45 lbs/ft³), and Sₓ is the capacity of the adsorbent (e.g., lb contaminant/lb adsorbent) for contaminant x at the expected adsorption temperature at the end of adsorbent life, e.g., after 3 or more years of service. The radius of the bed R (e.g., in ft), can be determined by any number of means, including calculation using the well-known Ergun equation, or modified Ergun equation:

ΔP/L=BμV+CρV² (3)

In Eq. 3, ΔP/L is the pressure drop (e.g., in psi/ft), B is a constant dependent on the adsorbent particles, μ is viscosity (e.g., in centipoise), ν is superficial gas velocity (e.g., in ft/min), ρ is gas density (e.g., in lbs/ft³), and C is a constant dependent on the adsorbent particles. R is generally selected such that the maximum pressure drop at flowing conditions is no more than some prescribed value, say 0.3 psi/ft, and the total pressure drop across the composite bed is no more than 6-8 psi if there is only a single bed support at the bottom of the bed. If the total pressure drop across the bed exceeds 6-8 psi, it may be necessary to install additional bed supports, or split the vessel into two vessels in series. Note that ν (e.g., in ft/min) is related through Q (MMSCF/D) and R (in ft) by:

ν=(Q/3600)(14.696/P)+460)/520)/(πR²) (4)

where P is pressure (in psia), and T is temperature (in Fahrenheit). The length of the mass transfer zone can be estimated in the following manner:

L_{MTZ}_{ₓ}=Kₓ(ν/35)^{0.3} (5)

where L_{MTZ}_{ₓ} is the length of the mass transfer zone of contaminant x (in feet), K is a constant dependent on both the size of the adsorbent particles and the strength of the contaminant-adsorbent interaction, and ν is the superficial velocity of gas in the bed (in ft/min).

For water, K_{H}_{₂}_{O}=13.6 C, where C is the average particle size is in inches. For other adsorbates, K=(13.6/α) C, where α is a factor accounting for the strength of the contaminant-adsorbent interaction relative to that of the interaction of water and typical molecular sieve. This constant can be estimated from the ratio of the slope of the 25° C. isotherm of the contaminant on the adsorbent to the slope of the 25° C. isotherm of water on molecular sieve 4A as coverage (or partial pressure of adsorbate) approaches zero. So, a more weakly-bound adsorbate (lower slope on the isotherm) has an α<1, and consequently a longer MTZ than water.

In some embodiments, after a total bed length for each adsorbent has been calculated, the plurality of adsorbents may be layered in a particular order based on the strength of adsorption of each contaminant to its respective adsorbent. The order may ensure maximum decontamination to meet quality specifications since the more strongly-held contaminants can be removed at the onset of the feed stream 208 entering the column 206. Strongly-adsorbed contaminants will displace weakly-held contaminants, which will flow further down the vessel to adsorbents better suited to adsorb them.

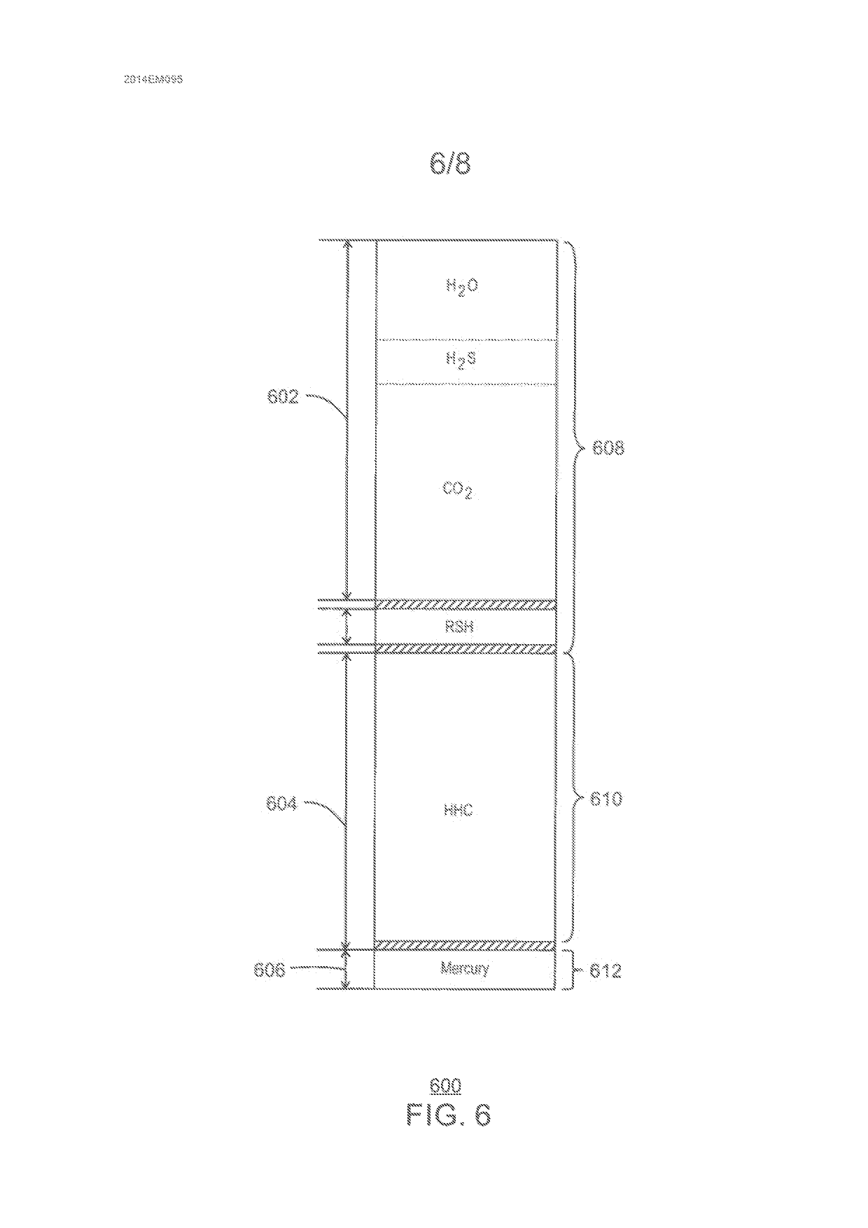

The following are hypothetical examples, assuming a low volume content of both CO₂ and HHC, in various methods of gas production including, shale gas production, LNG production, and reservoir production. The composition and properties of different production fluids from the varied production methods are shown in Tables 1, 3, and 5, respectively. The design specifications for the production of shale gas, LNG, and reservoir production, are shown in Tables 2, 4, and 6, respectively. Additionally, the design of each adsorption column is discussed with respect to FIGS. 6, 7, and 8. In some embodiments, the gas composition may include H₂O, H₂S, CO₂, HHC, RSH, and mercury as potential contaminants to be adsorbed and removed from a feed gas stream.

### Design of an Adsorption Bed for the Production of Shale Gas

TABLE 1
Properties for the Production of Shale Gas

| Flow rate | 10 MMCF/D |
|---|---|
| Pressure | 150 psia |
| Temperature | 90° F. |
| H₂O (lbs/MMCF) | 7 |
| H₂S (ppm) | 10 |
| CO₂ (vol %) | 0.15 |
| Organic Sulfur (ppm) | 20 |
| HHC (vol %) | 0.33 |

TABLE 2
Design Specifications for a Column in the Production of Shale Gas to meet
LNG specification.

| | |
|---|---|
| No. of Beds | 2 |
| Vessel Diameter (ft) | 3.5 |
| H₂O sieve (ft) | 3.0 |
| H₂S sieve (ft) | [[3.5]] |
| CO₂ sieve (ft) | [[14.3]] |
| RSH sieve (ft) | 0.3 |
| HHC adsorbent (ft) | 24* |

*in a separate 6 ft diameter bed

FIG. 6 is an illustration of an embodiment of an adsorption bed 600 in a column for shale gas production including a plurality of layered adsorbents shown in a particular order based on a calculated bed length for each adsorbent. The properties of the shale gas can be seen in Table 1. Based on Equations 1-5, a calculated length for each adsorbent layer based on a specific contaminant can be seen in Table 2. The adsorption bed can include three (3) adsorption layers provided in an order including a first layer 602 for H₂O vapor, H₂S, CO₂, and RSH contaminants, a second layer 604 for HHC, and a third layer 606 for mercury. A 4 A sieve 608 may be implemented for the first layer 602, a 13X sieve 610 for the second layer 604, and a standard non-regenerable guard bed 612 as the third adsorption layer 606 for the mercury contaminant (not included in Tables 1 and 2).

In FIG. 6, the order of the plurality of adsorbents can include placing the adsorbent for the removal of H₂O vapor before other adsorbents. This may be due in part to H₂O molecules holding to the surface of the 4A sieve with a strong attractive force. Thus, the adsorption strength of the H₂O molecules may be the strongest amongst the other contaminants since its attraction to the surface of the sieve is greater than its tendency to remain in the vapor phase. Thus, the 4A sieve may be initially saturated with H₂O vapor and thereafter, with H₂S, CO₂, and RSH as shown in FIG. 6. Accordingly, in some embodiments, the order of the plurality of adsorbents for particular contaminants can include H₂O, H₂S, CO₂, RSH, HHC, and mercury layers.

Design of an Adsorption Bed for the Production of LNG from a Lean Gas

TABLE 3
Properties for the Production of LNG from a Lean Gas

| Flow rate | 100 MMCF/D |
|---|---|
| Pressure | 900 psia |
| Temperature | 60° F. |
| H₂O (lbs/MMCF) | 20 |
| H₂S (ppm) | 3 |
| CO₂ (vol %) | 0.05 |
| Organic Sulfur (ppm) | 1 |
| HHC | 0.001 |

TABLE 4
Design Specifications for a Column in the Production of LNG

| | |
|---|---|
| No. of Beds | 3 |
| Vessel Diameter (ft) | 4.75 |
| H₂O sieve (ft) | 10.3 |
| H₂S sieve (ft) | 2.7 |
| CO₂ sieve (ft) | 10.3 |
| RSH sieve (ft) | 2.1 |
| HHC adsorbent (ft) | 2.8 |

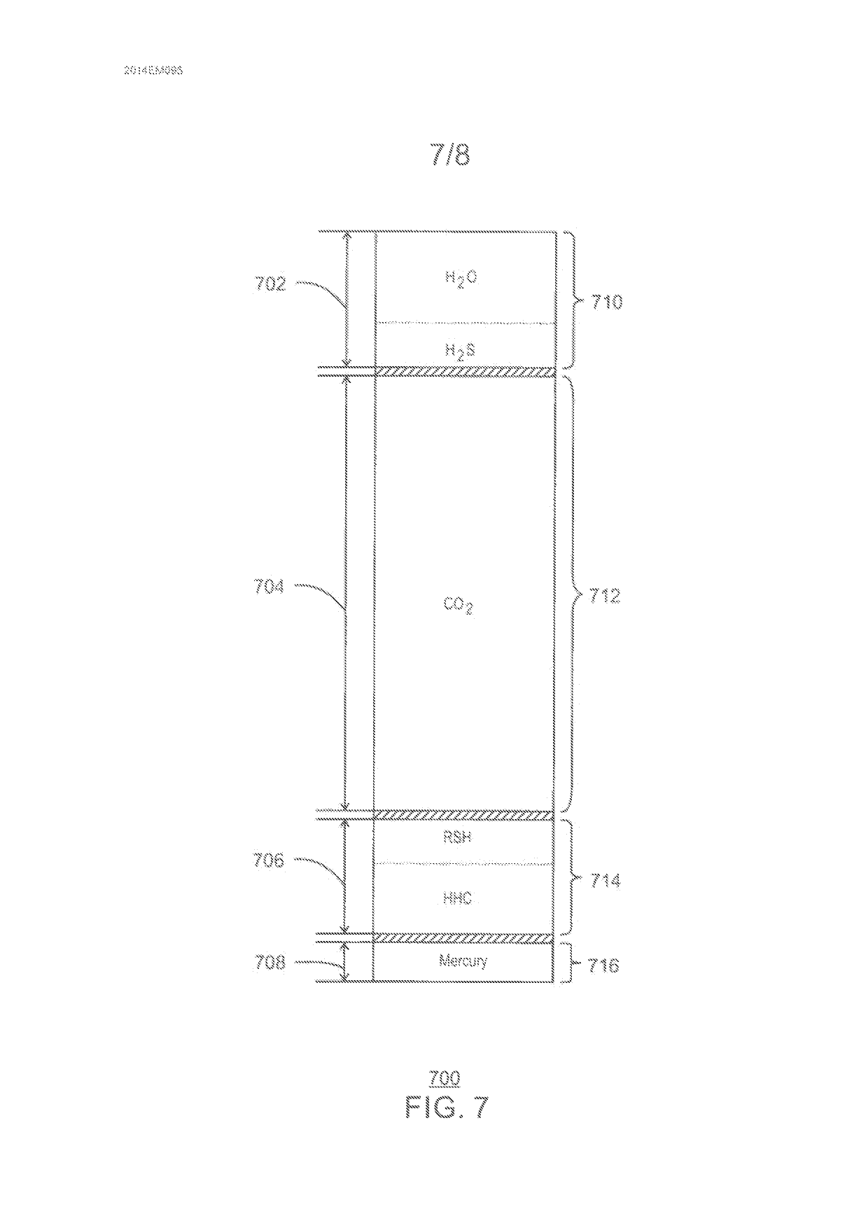

FIG. 7 is an illustration of an embodiment of an adsorption bed 700 in a column for LNG production including a plurality of layered adsorbents shown in a particular order based on a calculated length for each adsorbent layer. The properties of the natural gas can be seen in Table 3. Based on Equations 1-5, a calculated length for each adsorbent layer based on a specific contaminant can be seen in Table 4.

Due to the low concentration of CO₂ within the natural gas, the adsorption bed 700 may include a separate adsorption layer for CO₂. The adsorption bed can include four (4) layers of adsorbents provided in an order including a first layer 702 for H₂O and H₂S, a second layer 704 for CO₂, a third layer 706 for RSH and HHC, and a fourth layer 708 for mercury. As shown in FIG. 7, a 4A sieve 710 may be implemented for the first layer 702, a metal organic framework (MOF) solid 712 for the second layer 704, a 13X sieve 714 for the third layer 706, and a standard regenerable Hg guard bed 716 for the fourth layer 708 for the mercury contaminant (not discussed in Tables 3 and 4).

### Design of an Adsorption Column for the Production of a Reservoir Gas

TABLE 5
Properties for the Production of a Reservoir Gas

| Flow rate | 50 MMCF/D |
|---|---|
| Pressure | 700 psia |
| Temperature | 80° F. |
| H₂O (lbs/MMCF) | 50 |
| H₂S (ppm) | 4 |
| CO₂ (vol %) | 2.5 |
| Organic Sulfur (ppm) | 30 |
| HHC | 0.1 |

TABLE 6
Design Specifications for a Column in the Production of a Reservoir

| | |
|---|---|
| No. of Beds | 4 |
| Vessel Diameter | 3.75 |
| H₂O sieve (ft) | 14.5 |
| H₂Ssieve (ft) | 2.4 |
| CO₂ sieve (ft) | —* |
| RSH sieve (ft) | 1.7 |
| HHC adsorbent (ft) | 10.1 |

*Quantity of CO₂ to be removed too large to be done by mole sieve alone

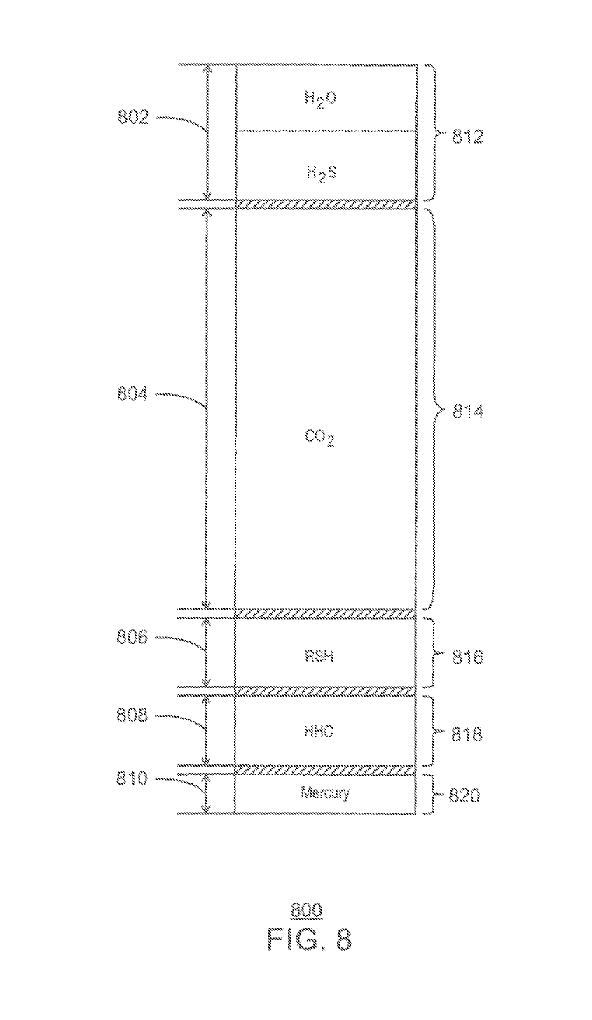

FIG. 8 is an illustration of an embodiment of an adsorption bed 800 in a column for reservoir production including a plurality of layered adsorbents shown in a particular order based on calculated bed lengths for each adsorbent. The properties of the production fluid from the reservoir can be seen in Table 5. Based on Equations 1-5, a calculated length for each adsorbent layer based on a specific contaminant can be seen in Table 6. The adsorption bed can include five (5) adsorption layers provided in an order including a first layer 802 for H₂O, a second layer 804 for H₂S, a third layer 806 for RSH contaminants, a fourth layer 808 for HHC, and a fifth layer 810 for mercury. As shown in FIG. 8, a 4A sieve 812 may be implemented for the first layer 802, a 5A sieve 814 for the second layer 804, a silica bed 816 for the third layer 806, a 13X sieve 818 for the fourth layer 808, and a standard regenerable guard bed 820 for the adsorption layer 810 (not discussed in Tables 5 and 6). Note that the CO₂ would have to be removed by some other means (e.g., physical solvent) to meet LNG specification, as the quantity to be removed is too large to be practically removed by known solid sorbents.

While the present techniques may be susceptible to various modifications and alternative forms, the embodiments discussed above have been shown only by way of example. However, it should again be understood that the techniques are not intended to be limited to the particular embodiments disclosed herein. Indeed, the present techniques include all alternatives, modifications, and equivalents falling within the true spirit and scope of the appended claims.

What is claimed is:

1. A gas purification column, comprising
a feed gas inlet for introducing a gas flow; and
a plurality of adsorbents to adsorb multiple components within the gas flow, wherein the plurality of adsorbents are layered within the column; wherein each adsorbent has a calculated bed length.

2. The gas purification column of claim 1, wherein each adsorbent is selected, based at least in part, on the type of component it may adsorb.

3. The gas purification column of claim 1, wherein multiple components of a gas flow includes water, hydrogen sulfide (H₂S), carbon dioxide (CO₂), heavy hydrocarbons (HHC), mercaptans (RSH), or mercury, in any combination thereof.

4. The gas purification column of claim 1, wherein layers of a plurality of adsorbents includes an adsorbent layer for water, an adsorbent layer for H₂S, an adsorbent layer for CO₂, an adsorbent layer for RSH, an adsorbent layer for HHC, and an adsorbent layer for mercury.

5. The gas purification column of claim 1, wherein a plurality of adsorbents is layered in an order within a column, based at least in part, on adsorption strength of each component to be adsorbed.

6. The gas purification column of claim 1, wherein a bed length of each adsorbent is based on a maximum weight percentage of component to be adsorbed by the adsorbent.

7. The gas purification column of claim 1, wherein a plurality of adsorbents is selected from a group comprising molecular sieves, alumina, silica gel, zeolites, metallic organic frameworks (MOFs), non-regenerable materials, or any combinations thereof.

8. The gas purification column of claim 1, wherein a plurality of adsorbents is in the form of particulates, extruded solids, functionalized solids, monoliths structures, or any combinations thereof.

9. The gas purification column of claim 1, comprising a silver-impregnated material to adsorb mercury.

10. The gas purification column of claim 1, comprising a plurality of support plates or floating screens to separate layers of adsorbents.

11. The gas purification column of claim 1, comprising a regeneration gas inlet for introducing a regeneration gas.

12. A column for the purification of a natural gas, comprising
a feed gas inlet for introducing a natural gas flow; and
a plurality of adsorbents to adsorb multiple components within the natural gas flow, wherein the plurality of adsorbents is layered within the column; wherein each adsorbent has a calculated bed length.

13. The column of claim 12, wherein multiple components include water, hydrogen sulfide (H₂S), carbon dioxide (CO₂), heavy hydrocarbons, mercaptans, or mercury, in any combination thereof.

14. The column of claim 12, wherein a bed length of each adsorbent is based on a maximum weight percentage of component to be adsorbed.

15. The column of claim 12, wherein each adsorbent is selected, based at least in part, on a type of component it will adsorb.

16. The column of claim 12, wherein a plurality of adsorbents is layered in an order, based at least in part, on an adsorption strength of each component to be adsorbed.

17. The column of claim 12, wherein an order of a plurality of adsorbents includes an adsorbent for water, an adsorbent for H₂S, an adsorbent for CO₂, an adsorbent for RSH, an adsorbent for HHC, and an adsorbent for mercury.

18. The column of claim 12, wherein a plurality of adsorbents is selected from a group comprising molecular sieves, alumina, silica gel, zeolites, metallic organic frameworks (MOFs), non-regenerable material, or any combinations thereof.

19. The column of claim 12, wherein a plurality of adsorbents is in the form of particulates, extruded solids, functionalized solids, or monoliths structures, or in any combination, thereof.

20. The column of claim 12, comprising a silver-impregnated material to adsorb mercury.

21. The column of claim 12, comprising a plurality of support plates or floating screens to separate layers of adsorbents.

22. The column of claim 12, comprising a regeneration gas inlet for introducing a regeneration gas.

23. A method of purifying a gas, comprising
layering a plurality of adsorbents in a column, wherein the plurality of adsorbents is layered in an order;
injecting a feed gas stream into the column, wherein the feed gas stream includes multiple components;
removing the multiple components from the feed gas stream; and
producing a purified gas.

24. The method of claim 23, wherein an order of a plurality of adsorbents is based, at least in part, on an adsorption strength of a component to be adsorbed.

25. The method of claim 23, comprising calculating a bed length for each of a plurality of adsorbents based, at least in part, on a maximum weight percentage of component to be adsorbed by each adsorbent.

26. The method of claim 23, comprising monitoring a percentage volume of component before and after adsorption.

27. The method of claim 23, comprising monitoring a purified gas to determine an occurrence of oversaturation in a column.

28. The method of claim 23, comprising regenerating a plurality of adsorbents to remove multiple components that are adsorbed by the plurality of adsorbents.

29. The method of claim 23, comprising splitting a feed gas stream into a first feed gas stream and a second feed gas stream.

30. The method of claim 23, comprising heating a second feed gas stream to produce a heated feed gas stream, wherein the heated gas stream is used as a regeneration gas stream to remove multiple components and to regenerate a plurality of adsorbents.

31. A method of designing an adsorption column for purification of a gas, comprising
analyzing the gas to identify a plurality of contaminants within the gas;
selecting adsorbents based on each type of contaminant;
generating a bed length for each adsorbent based on the maximum weight percentage of contaminant to be adsorbed; and
layering each adsorbent in the column based, at least in part, on the adsorption strength of the contaminant to be adsorbed by the adsorbent.

32. The method of claim 31, comprising placing separation plates or floating screens between layers of adsorbents.

33. The method of claim 31, wherein an adsorption column is packed with a plurality of adsorbents selected from a group comprising molecular sieves, alumina, silica gel, zeolites, metallic organic frameworks (MOFs), non-regenerable material, or in any combination thereof.

34. The method of claim 31, comprising providing a silver-impregnated material as an adsorbent.

35. The method of claim 33, wherein a plurality of adsorbents is in a form of particulates, extruded solids, functionalized solids, or monoliths structures, or in any combination thereof.

36. A method of designing an adsorption column for purification of a natural gas, comprising
analyzing the natural gas to identify a plurality of contaminants with the natural gas;
selecting adsorbents based on each type of contaminant;
generating a bed length for each adsorbent based on the maximum weight percentage of contaminant to be adsorbed; and
layering each adsorbent in the column based, at least in part, on the adsorption strength of the contaminant to be adsorbed by the adsorbent.

37. The method of claim 36, comprising providing separation plates or floating screens between layers of adsorbents.

38. The method of claim 36, wherein an adsorption column is packed with a plurality of adsorbents selected from a group comprising molecular sieves, alumina, silica gel, zeolites, metallic organic frameworks (MOFs), non-regenerable material, or any combination thereof.

39. The method of claim 36, comprising providing a silver-impregnated material as an adsorbent.

40. The method of claim 36, wherein a plurality of adsorbents are in a form of particulates, extruded solids, functionalized solids, or monoliths structures, or in any combination thereof.
